(19) United States
(12) Patent Application Publication
(10) Pub. No.: US 2015/0215394 A1
(43) Pub. Date: Jul. 30, 2015

(54) LOAD DISTRIBUTION METHOD TAKING INTO ACCOUNT EACH NODE IN MULTI-LEVEL HIERARCHY

(71) Applicant: Hitachi, Ltd., Tokyo (JP)

(72) Inventors: Naokazu Nemoto, Tokyo (JP); Yasuhiro Takahashi, Tokyo (JP); Kansuke Kuroyanagi, Tokyo (JP); Kunihiko Toumura, Tokyo (JP)

(21) Appl. No.: 14/419,769

(22) PCT Filed: Aug. 6, 2013
(86) PCT No.: PCT/JP2013/071210

§ 371 Date: Feb. 5, 2015

(30) Foreign Application Priority Data
Aug. 10, 2012 (JP) 2012-177712

(51) Int. Cl. H04L 29/08; H04L 12/26; G06F 9/50

(52) U.S. Cl. CPC H04L 67/1008; G06F 9/505; H04L 43/0817

(57) ABSTRACT

To equalize loads of a hierarchy-type network system, the loads at the lower levels of the system are taken into account. In an arbitrary 3-level hierarchy (n to n+2 levels), a node of the n+1 level obtains, from each of one or more nodes of the n+2 level, load information thereof, calculates the spare resource-amount thereof on the basis of the obtained load information and load information thereof, and transmits the calculated spare resource-amount thereof to a node of the n level. The node of the n level calculates weighting values on the basis of the spare resource-amounts obtained from each of the nodes of the n+1 level, and distributes a received processing request to either one of the nodes of the n+1 level on the basis of the calculated weighting values.

### INCORPORATION BY REFERENCE

The present application claims priority from Japanese Patent Application No. 2012-177712, filed on Aug. 10, 2012, the entire disclosure of which is incorporated herein by reference.

### TECHNICAL FIELD

The subject matter disclosed herein relates to a plurality of relay devices that are set up on server devices or communications paths between terminals and the server devices in network systems the representatives of which are WWW (World Wide Web), mail system, and data center.

### BACKGROUND ART

A client terminal makes an access, via relay devices such as switch, firewall, and gateway, to a server device (hereinafter, referred to as “server”) that is connected to LAN (Local Area Network) or WAN (Wide Area Network). The communications amount exchanged between the server device such as WWW and the client terminal is now increasing because of the prevalence of terminals connected to wired networks or wireless networks, the high-performance implementation and high-function implementation of mobile terminals, the high-speed implementation and high-band implementation of wireless communications networks, and the large-capacity implementation of contents such as motion picture and music. Also, the large-capacity information such as communications log and each type of sensor information created under an environment like this continues to be accumulated. The large-capacity information like this needs to be managed with high efficiency.

Under the problems like these, the communications amount passing through the relay devices such as switch, firewall, and gateway within carrier and data center system has become enormous, and continues to increase more than ever before. In accompaniment with this increase in the communications amount, there is an urgent necessity for enhancing processing capability of the relay devices and the servers. As the capability enhancement measures, there can be mentioned a technique of intending an enhancement in hardware performance, and a technique of applying a decentralization processing to a request. In general, the former is referred to as “scale-up”; while the latter is referred to as “scale-out”. In the countermeasure based on the scale-up, there are problems such as service stop due to single failure point and service stop at hardware update time. The carrier and data-center operation provider often intend the scale-out-type capability enhancement that makes it possible to address the communications-amount increase without stopping the services. Also, they often intend the scale-out-type capability enhancement not only when addressing the communications-amount increase, but also when performing processing execution and management of large amount of information.

### CITATION LIST

### Patent Literature

PATENT LITERATURE 1: WO2008/129597
PATENT LITERATURE 2: JP-A-2010-279238

### Non Patent Literature

NON PATENT LITERATURE 1: Microsoft Corporation, “Layered Application Guidelines”, [retrieved on Jun. 13, 2012], Internet <URL: http://msdn.microsoft.com/en-us/library/ee658109.aspx>

### SUMMARY

### Technical Problem

In general, nodes such as servers within a system are connected to each other in a multi-layered manner in order to efficiently satisfy the availability, scalability, and the like. In this system constructed in a multi-layered manner, a processing request is transferred from a node of an upper layer to a node of a lower layer. This technological content is disclosed in NON PATENT LITERATURE 1. In a system like this which is constructed in a multi-layered manner, the failure avoidance or the like by the monitoring between nodes is implemented which are in a parent-child relationship, and whose mutual layers are adjacent to each other. However, the monitoring between nodes is not performed which are in a parent-grandchild relationship, and between whose mutual layers one or more layers exist. For this reason, the parent node transfers a processing request to the child node without recognizing a failure of the grandchild node, thereby giving rise to occurrence of the state of service-no-response.

A technology for solving this problem is disclosed in PATENT LITERATURE 1 (paragraphs 0051 through 0055, 0056 through 0065, 0073 through 0105, and 0106 through 0116). In the technology disclosed in PATENT LITERATURE 1, in a system constructed in a multi-layered manner, load information including dead-or-alive information is aggregately managed into the upper node at a certain single location from all nodes of all of the layers. In the present technology, the load information is aggregated into the single location. As a result, even if a failure has occurred in a node of whatever layer, the nodes on their way to this node can be so instructed as not to pass through the failure-occurred path. This means the content of preventing the service-no-response caused by a failure of a lower node.

Also, in the present technology, the load is managed in the concentrated manner. As a result, if the load exceeds a certain threshold value, the system can be managed in a stable manner by not transferring a processing request to that node.

Also, the following technology is disclosed in PATENT LITERATURE 2 (paragraphs 0043 through 0044): In a system constructed in a multi-layered manner, under an environment where decentralized power-sources are sequentially added thereto, the monitoring control over enormous number of power consumers is implemented by managing the entire power supply in a stable manner. In the technology disclosed in PATENT LITERATURE 2, the following content is disclosed: In the power-decentralization/power-feed system of a tree structure that is constructed in a radial manner from the upper layers to the lower layers such that a monitoring center for controlling the power flow is deployed at its top, the consumed power amounts or generated power amounts are collected and aggregated from a monitoring controller of one layer below. After that, the resultant consumed power amount or generated power amount is reported to a monitoring controller of one layer above. Moreover, the consumed power amount or generated power amount is instructed to the monitoring controller of one layer below such that a monitoring controller of the monitoring center is employed as the starting point. In the technology disclosed in PATENT LITERATURE 2, the information about the lower layer is aggregated and reported to the upper layer in the system of the tree structure. It is shown that the way of thinking like this allows implementation of the decentralization control where the situation of the lower layer is taken into consideration.

In the technology disclosed in PATENT LITERATURE 1, however, the communications cost becomes large. This is because the load information on all the nodes of the system is aggregated into the particular node. Also, when a processing request is so controlled as not to be transferred to a node whose load exceeds a certain threshold value, the node whose load exceeds the threshold value does not accept the processing request during a constant time-period. As a result, the processing request is executed in another node, and accordingly the loads on the entire system are not equalized.

Also, when the technology disclosed in PATENT LITERATURE 2 is applied to the system constructed in a multi-layered manner, no consideration is given to the loads on the nodes on their way along the path. Accordingly, it is difficult to implement the equalization of the loads. Moreover, as the mode of the decentralization system, in addition to the tree structure constructed in a radial manner from the upper layers to the lower layers, the mode is also common where the nodes are connected to each other in an n:m manner. Also, in the configuration having a plurality of roots, a system of the decentralization mode is possible where DNS (Domain Name System) is utilized. The technology disclosed in PATENT LITERATURE 2 is inapplicable in the systems of the connection modes like these.

### Solution to Problem

In the present specification, the following load decentralization technology is disclosed: Between nodes that are in a parent-child relationship in a system constructed over three or more layers, a parent node carries out this load decentralization technology on the basis of the loads imposed on one or more nodes in each layer of a plurality of lower layers.

According to the disclosed technology, in arbitrary three layers of a system constructed over three or more layers, the loads are decentralized on the basis of the free-resource amounts of one or more nodes (referred to as “child nodes”) belonging to the second layer.

For example, a child node calculates the free-resource amounts of the layers lower than or equal to the child node on the basis of load information acquired from one or more nodes (referred to as “grandchild nodes”) belonging to the third layer, and load information on the child node itself. The child node transmits the calculated free-resource amounts to a node (referred to as “parent node”) of the upper layer. Moreover, the parent node calculates weight values on the basis of the free-resource amounts acquired from the one or more child nodes. The parent node distributes a received processing request to any one of the child nodes on the basis of the calculated weight values, thereby implementing the equalization of the loads.

The loads are decentralized by distributing the processing request so that the loads imposed on the respective child nodes become almost equalized over the plurality of layers. This eliminates a node whose load is outstandingly high among the plurality of nodes. Accordingly, if, for example, a burst-mannered processing request is processed, it is possible to prevent occurrence of the service stop and response worsening caused by resource exhaustion in the high-load node.

According to the above-described aspect, even if a parent node or management node does not acquire the dead-or-alive monitoring information or load information on the nodes of two or more layers below, it is possible to implement the load decentralization while grasping the situation of each node.

Also, even if a system constructed in a multi-layered manner is configured such that it has a plurality of root nodes, or is configured such that lower-layer nodes are connected to a plurality of upper-layer nodes in an (n:m) manner, it is possible to implement the load decentralization.

Also, since the load decentralization based on the free-resource amounts is carried out, it becomes possible to implement the equalization of the loads in a different hardware environment.

According to the disclosure, it becomes possible to implement the more-equalized load decentralization in a system of a multi-layered structure.

The other objects, features and advantages of the disclosure will become apparent from the following description of the embodiments associated with the accompanying drawings.

### BRIEF DESCRIPTION OF THE DRAWINGS

FIG. 1 is a diagram for exemplifying the basic configuration of a computer system.

FIG. 2 is a diagram for exemplifying the configuration of each node that constitutes the computer system.

FIG. 3 is a diagram for exemplifying the configuration of a weight table for registering the weight, free-resource amount, and transfer destination held by each node.

FIG. 4 is a diagram for exemplifying the configuration of a load information management table for registering the load information held by each node.

FIG. 5 is a diagram for exemplifying the configuration of a load basic information management table for registering the information on hardware spec held by each node.

FIG. 6 is a diagram for exemplifying the configuration of a distribution-destination node management table for registering the distribution-destination node information held by each node.

FIG. 7 is a diagram for exemplifying the configuration of a load history management table for registering the history of the load information held by each node.

FIG. 8 is a flowchart for exemplifying the configuration of hardware-spec information acquisition processing contents executed in a distribution-source node.

FIG. 9 is a flowchart for exemplifying the configuration of load information acquisition processing contents executed in the distribution-source node.

FIG. 10 is a flowchart for exemplifying the processing contents for calculating the free-resource amount and weight executed in the distribution-source or distribution-destination node.

FIG. 11 is a flowchart for exemplifying the distribution processing contents executed in the distribution-source node.

FIG. 12 is a diagram for exemplifying the node connection configuration of a computer system.

FIG. 13 is a diagram for exemplifying the configuration of the computer system.

FIG. 14 is a diagram for exemplifying the configuration of the computer system.

FIG. 15 is a diagram for exemplifying the configuration of each node that constitutes the computer system.

FIG. 16 is a diagram for exemplifying the configuration of a group free-resource amount management table for registering the free-resource amount in the parent-node unit held by each node.

FIG. 17 is a flowchart for exemplifying the processing contents for registering the free-resource amount in the parent-node unit executed in the distribution-destination node.

FIG. 18 is a flowchart for exemplifying the processing contents for calculating the free-resource amount in the parent-node unit executed in the distribution-source or distribution-destination node.

FIG. 19 is a flowchart for exemplifying the distribution processing contents between the parent nodes executed in the distribution-source node.

FIG. 20 is a diagram for exemplifying the configuration of a computer system.

FIG. 21 is a diagram for exemplifying the configuration of a DNS server.

FIG. 22 is a diagram for exemplifying the configuration of each node that constitutes the computer system.

FIG. 23 is a diagram for exemplifying the configuration of a DNS information management table for registering the DNS information held by each node.

FIG. 24 is a diagram for exemplifying the configuration of a DNS table for registering the DNS table held by the DNS server.

FIG. 25 is a flowchart for exemplifying the weighted-distribution processing contents executed in the DNS server.

FIG. 26 is a flowchart for exemplifying the processing contents for transmitting, to the DNS server, the weighted information between the parent nodes executed in the parent node.

FIG. 27 is a flowchart for exemplifying the weighted-information reception processing contents executed in the DNS server.

FIG. 28 is a flowchart for exemplifying the outline of the processing contents for calculating the free-resource amount and weight executed in the distribution-source node.

### DESCRIPTION OF THE EMBODIMENTS

### Embodiment 1

The configuration of a computer system in the present embodiment is that a plurality of nodes and a client terminal are connected to each other via a network.

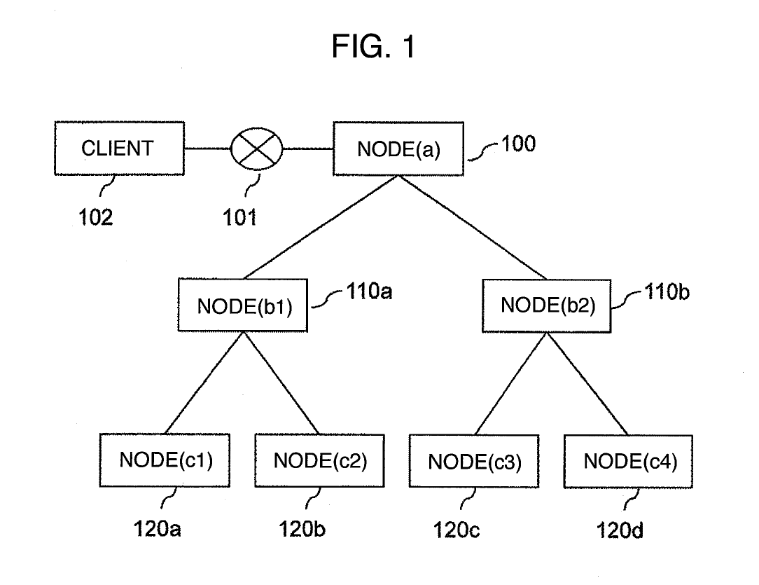

FIG. 1 illustrates a configuration example of the computer system where a plurality of nodes are connected to each other into a tree structure (one or more lower-layer nodes are connected to one upper-layer node) via a network. A parent node (a) 100 is connected to a client 102 via a network 101. The parent node (a) 100 is connected to a child node (b1) 110a and a child node (b2) 110b. The child node (b1) 110a is connected to a grandchild node (c1) 120a and a grandchild node (c2) 120b. The child node (b2) 110b is connected to a grandchild node (c3) 120c and a grandchild node (c4) 120d. In the present embodiment, the configuration is indicated where the plurality of grandchild nodes 120a through 120b and 120c through 120d are connected to the child nodes 110a and 110b, respectively. However, a configuration is also allowable where any one of the grandchild nodes 120a through 120d does not exist, or a configuration is also allowable where nodes are further connected to lower layers lower than the layer of the grandchild nodes.

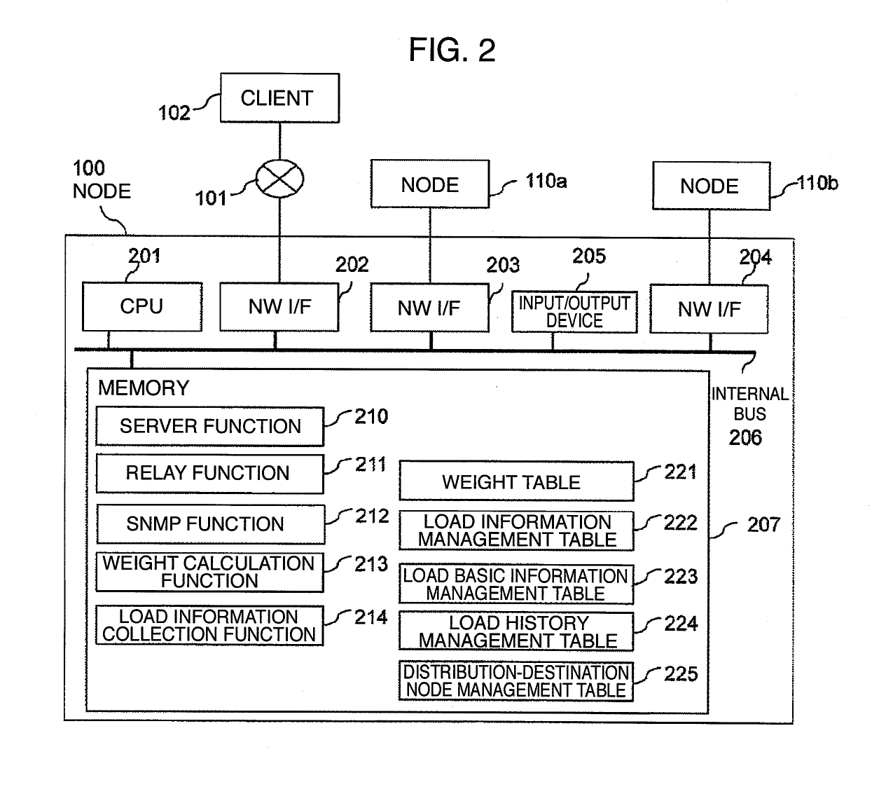

FIG. 2 is a diagram for illustrating a configuration example of each node. In the present embodiment, the configuration example of each node is indicated where the parent node (a) 100, the child nodes 110a through 110b, and the grandchild nodes 120a through 120d assume one and the same configuration. However, a configuration is also allowable where the parent node (a) 100, the child nodes 110a through 110b, and the grandchild nodes 120a through 120d carry out different processings, respectively. For example, like the Web three layers, a configuration is also acceptable where the parent node (a) 100 is a Web server, and the child nodes 110a through 110b are application servers, and the grandchild nodes 120a through 120d are data servers. Here, as the representative, the explanation will be given below concerning the configuration example of the parent node (a) 100.

The parent node (a) 100 is implemented on a computer where one or more CPUs 201, one or more network interfaces (NW I/Fs) 202 through 204, an input/output device 205, and a memory 207 are connected to each other via a communications path 206 such as internal bus. The NW I/F 202 is connected to the client 102 via the network 101. The NW I/Fs 203 and 204 are connected to the child nodes 110a through 110b via networks. The networks via which the client 102 and the child nodes 110a through 110b are connected may be one and the same network. The memory 207 stores therein respective programs, and a weight table 221, a load information management table 222, a load basic information management table 223, a load history management table 224, and a distribution-destination node management table 225. Here, the respective programs are executed by the CPUs 201, and implement, as processes on respective computers, a server function 210, a relay function 211, a SNMP function 212, a weight calculation function 213, and a load information collection function 214.

The respective programs may be stored into the memory 207 of each node 100, 110 in advance, or may be introduced into the memory 207 of each node from another device via a usable medium. This medium refers to a memory medium removal/insertable from/into a not-illustrated external device interface, or a communication medium (i.e., wired, wireless, or optical network connected to the NW I/Fs 202 through 204, or carrier wave or digital signal propagating through the network). The server function 210 executes the processing of a request received from the client 102. The relay function 211 executes a processing of moving to a lower node, a processing request received from the client 102. The SNMP function 212 executes a processing of transmitting the load information between nodes. The weight calculation function 213 calculates a distribution weight between lower-layer nodes on the basis of the load information acquired from the lower-layer nodes. The load information collection function 214 executes a collection processing of collecting the load information between the nodes.

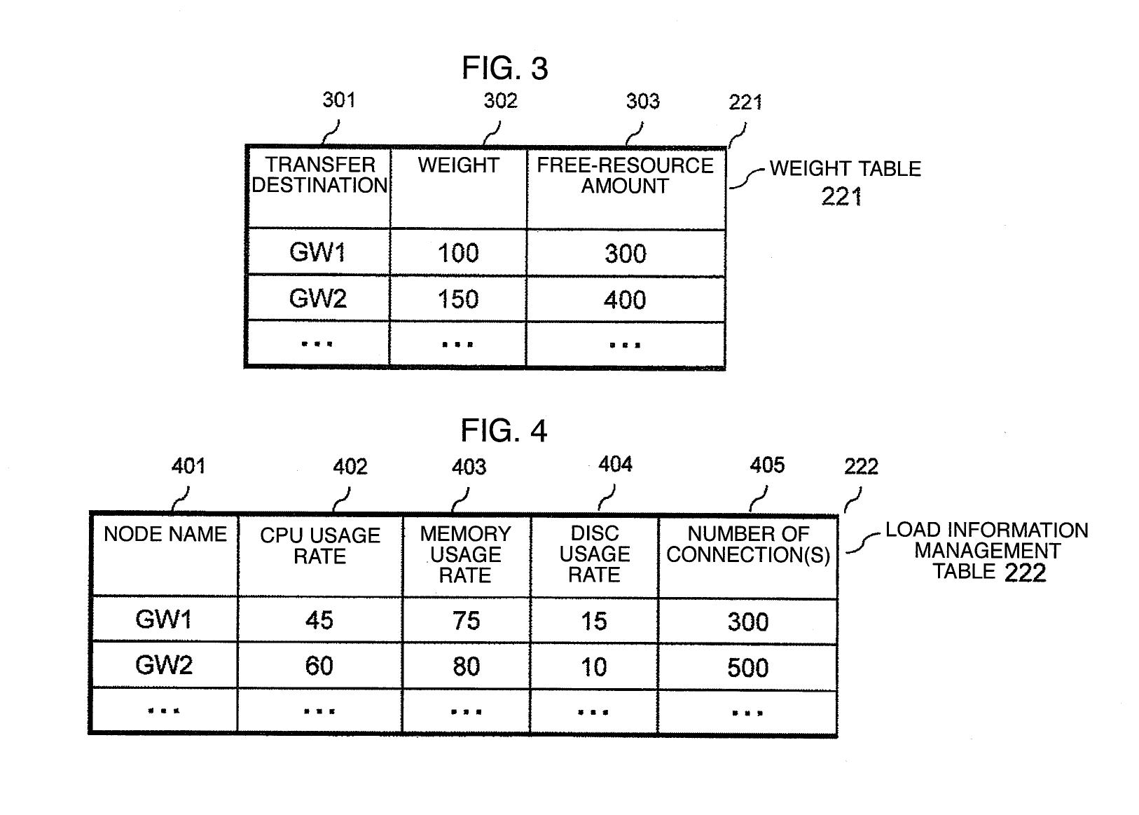

FIG. 3 is a diagram for illustrating an example of the weight table 221 included in each node. The relay function 211 of each node executes the distribution of a processing request in accordance with the weight ratio. As the distribution method, various methods exist in general. In the present embodiment, the distribution based on the round-robin method is assumed, but the other methods are also usable.

A transfer destination field 301 of the weight table 221 stores therein the name of a node to which a processing request received by the present node of the weight table is to be transferred. A weight field 302 thereof stores therein the weight value corresponding to the load amount of the transfer-destination node. A free-resource amount field 303 thereof stores therein the free-resource amount of the transfer-destination node.

The free-resource amount is a value that is calculated on the basis of the load information collected from the transfer-destination node. Concretely, the free-resource amount is represented by, for example, the product of the node's free-CPU usage rate (1—CPU usage rate), number of CPU core(s), and CPU clock speed. In this example, only the CPU is selected as the load monitoring target. It is also allowable, however, that not only the CPU, but also the monitoring target resources such as network, disc, memory, and data size are included within the load monitoring target. Also, the free-resource amount includes the load amount of a node group of the layer that is further lower than the layer of the transfer-destination node, including the load amount of the transfer-destination node.

For example, when the nodes are configured which are constructed over the three layers such as the parent, child, and grandchild as are illustrated in FIG. 1, the child node (b1) 110a collects the load information (number of CPU core(s), CPU clock speed, and CPU usage rate) from the grandchild node (c1) 120a and the grandchild node (c2) 120b. Next, the child node (b1) 110a calculates the free-resource amounts of the grandchild node (c1) 120a and the grandchild node (c2) 120b, using the load information collected. Moreover, as the child node (b1) 110a, the child node (b1) 110a transmits, to the parent node (a) 100, the sum-total value of the sum-total value of the free-resource amounts of the grandchild nodes, and the free-resource amount of the child node (b1) 110a itself. In this way, by reporting the free-resource amount to an upper-layer node, it becomes possible for the parent node (a) 100 to measure the load amounts including the nodes that are lower than or equal to the child node (b1) 110a and the child node (b2) 110b. As a result, it becomes possible to carry out the load decentralization where the nodes from the child nodes up to the grandchild nodes are taken into consideration.

The weights described here are ratios that are allocated to distribution-destination nodes in correspondence with the number of the distribution-destination nodes. For example, when one parent node distributes a processing request to two child nodes, if the ratio with which the processing request is caused to be transferred to one child node is 70%, and if the ratio with which the processing request is caused to be transferred to the other child node is 30%, the weights can be represented as being 70 and 30, respectively.

FIG. 4 is a diagram for illustrating an example of the load information management table 222 included in each node. The load information collection function 214 of each node executes a load information acquisition request to a lower-layer node for each constant time specified by the manager. Moreover, the collection function 214 acquires the load information from the lower-layer node, then registering the acquired load information into the load information management table 222. If registration information has already existed therein at the time of the registration, this registration information is overwritten by the newly acquired load information. The nodes to be registered into this load information management table 222 are only the nodes equipped with no lower-layer node (which correspond to the grandchild node (c1) 120a through grandchild node (c4) 120d in FIG. 1), and each node itself. A node name field 401 of the load information management table 222 stores therein the node identifier for identifying each node. A CPU usage rate field 402 thereof stores therein the CPU usage rate of the node. A memory usage rate field 403 thereof stores therein the memory usage rate of the node. A disc usage rate field 404 thereof stores therein the disc usage rate of the node. A connection number field 405 thereof stores therein the number of connection(s) of the node.

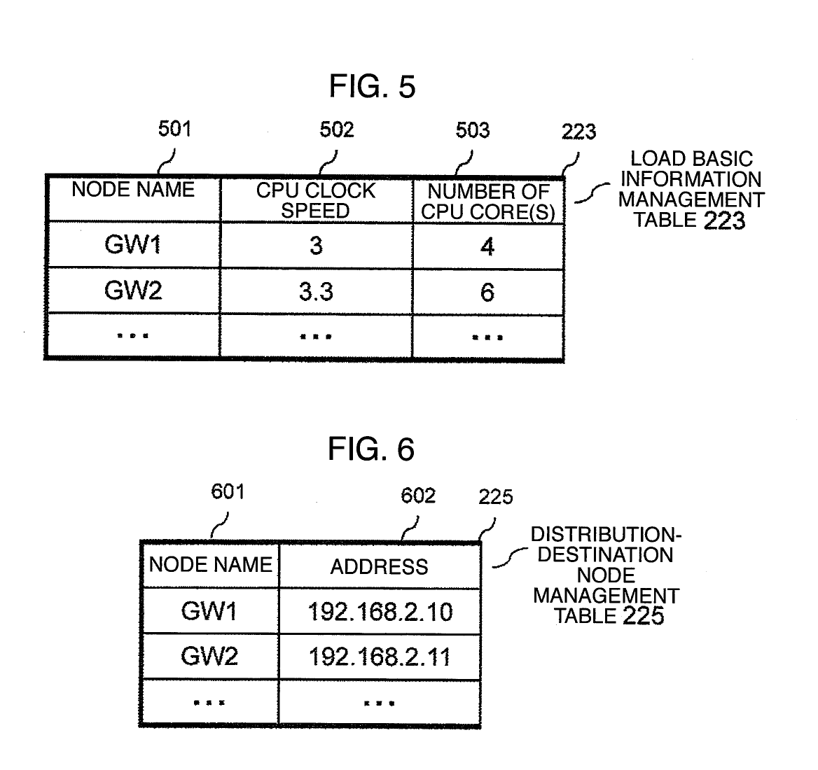

FIG. 5 is a diagram for illustrating an example of the load basic information management table 223 included in each node. The load information collection function 214 of each node executes a hardware-spec information acquisition request to a lower-layer node. Moreover, the collection function 214 acquires the hardware-spec information from the lower-layer node, then registering the acquired hardware-spec information into the load basic information management table 223. A node name field 501 of the load basic information management table 223 stores therein the node identifier for identifying each node. A CPU clock speed field 502 thereof stores therein the CPU clock speed of the node. A CPU core number field 503 thereof stores therein the number of CPU core(s) of the node. In the present embodiment, the CPU clock speed and the number of CPU core(s) are employed as the examples of the hardware-spec information. It is also allowable, however, to include such values as network band, CPU type, disc access speed, and memory amount.

FIG. 6 is a diagram for illustrating an example of the distribution-destination node management table 225 included in each node. The distribution-destination node management table 225 registers therein the node identifiers and addresses corresponding thereto, and connects them to each other. A node name field 601 of the distribution-destination node management table 225 stores therein the node identifier for identifying each node. An address field 602 thereof stores therein the address of the node.

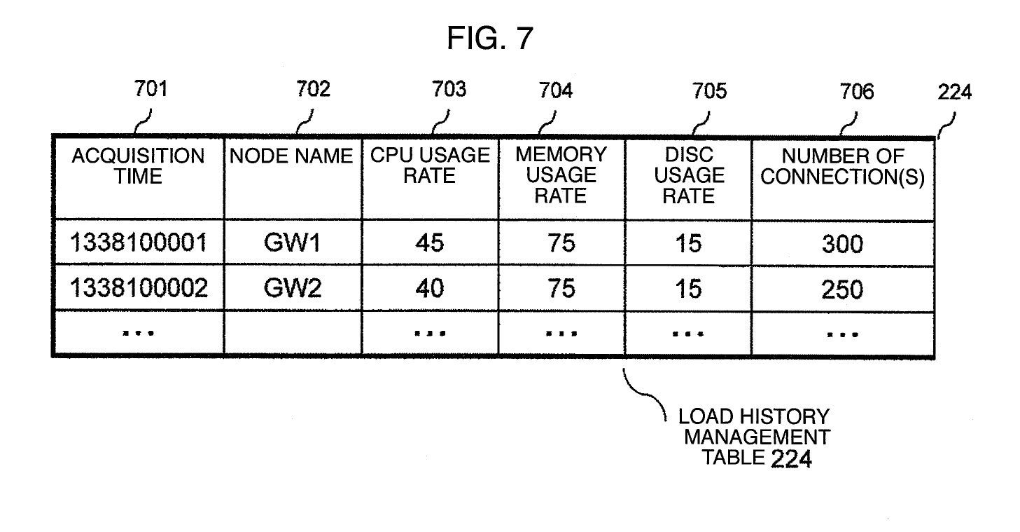

FIG. 7 is a diagram for illustrating an example of the load history management table 224 included in each node. The load history management table 224 stores therein the load information on the distribution-destination nodes and each node itself during a constant time-period. An acquisition time field 701 of the load history management table 224 stores therein the load information acquisition time. A node name field 702 thereof stores therein the node identifier for identifying each node. A CPU usage rate field 703 thereof stores therein the CPU usage rate of the node. A memory usage rate field 704 thereof stores therein the memory usage rate of the node. A disc usage rate field 705 thereof stores therein the disc usage rate of the node. A connection number field 706 thereof stores therein the number of connection(s) of the node.

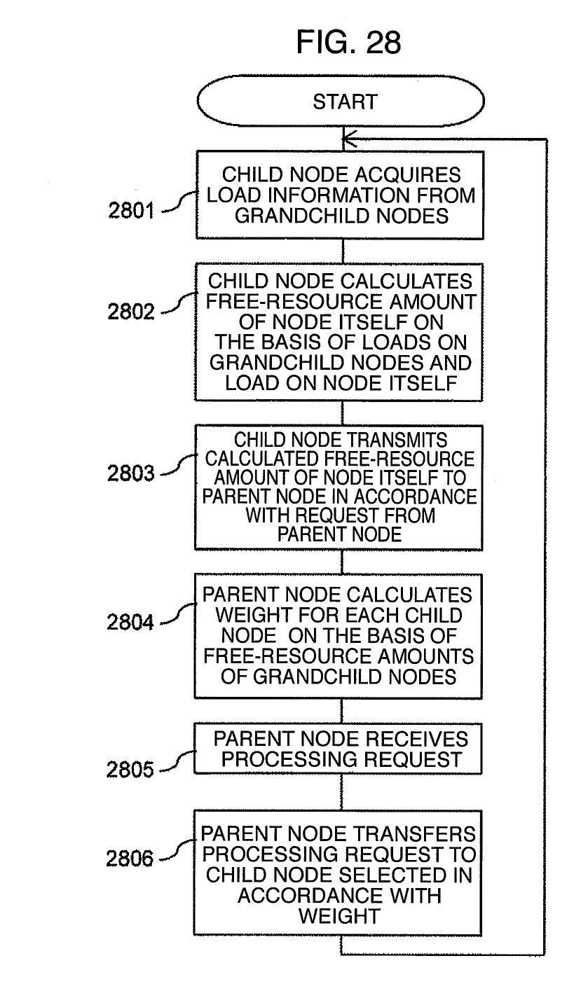

FIG. 28 is a flowchart for illustrating an example of the outline of a processing flow in the following case: In arbitrary three layers of a system whose system configuration is constructed over three or more layers as illustrated in FIG. 1, the load information collection function 214, the weight calculation function 213, the SNMP function 212, and the relay function 211 of a node (referred to as “child node”) belonging to the second layer collects the load information from nodes (referred to as “grandchild nodes”) belonging to the third layer. Moreover, these functions calculate the free-resource amounts on the basis of the collected load information on the grandchild nodes and the load information on the node itself (child node), then transmitting the calculated free-resource amounts to a node (referred to as “parent node”) belonging to the first layer. Furthermore, the child node distributes, to the grandchild nodes, a processing request transmitted from the parent node.

The load information collection function 214 of the child node collects the load information from the grandchild nodes (step 2801).

In accordance with the above-described method for example, the weight calculation function 213 of the child node calculate the free-resource amount of the node itself where the load information on the grandchild nodes is also taken into consideration (step 2802).

Having received a load information acquisition request from the load information collection function 214 of the parent node, the SNMP function 212 of the child node transmits, to the parent node, the free-resource amount calculated at the step 2802 (step 2803).

In order to distribute a processing request to a child node, and on the basis of the free-resource amount of the child node, the weight calculation function 213 of the parent node calculates weights that become a distribution ratio of the processing request (step 2804).

In accordance with the weights calculated at the step 2804, the parent node distributes the processing request, which the parent node has received (step 2805), to any one of the child nodes (step 2806). The relay function 211 of the child node receives the processing request that the parent node has distributed.

After the step 2806, the processing returns to the step 2801, then repeating the processings.

Incidentally, the child node that has received the processing request executes the processing within the node itself, if the node itself becomes the parent node of the above-described three layers. After that, the child node performs a further distribution of the processing request by performing basically the same processings

Also, the processings at the steps 2801 through 2804 and the processing at the step 2805 are independent of each other. Accordingly, they can be performed in parallel to each other. In that case, the relay function 211 of the parent node determines the distribution-destination node by making reference to the pre-calculated weights at the time when the parent node performs the step 2805.

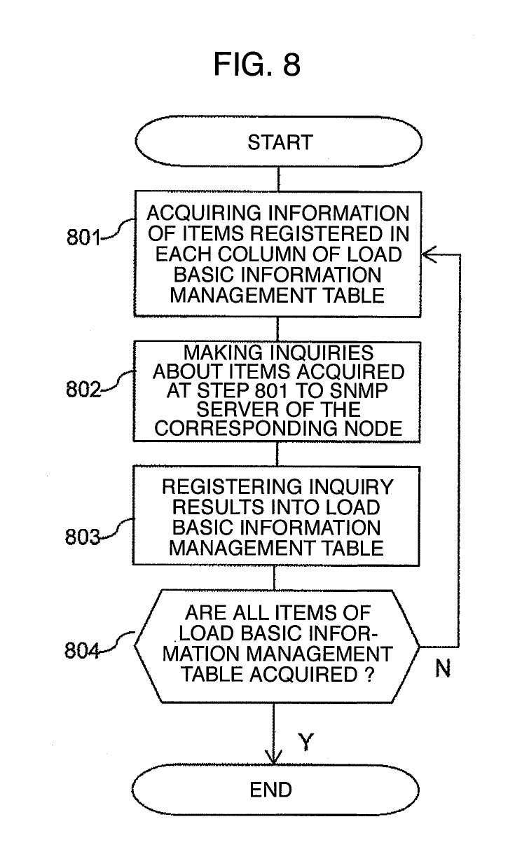

Hereinafter, referring to FIG. 8 through FIG. 11, the explanation will be given below concerning the details of each step of the flowchart illustrated in FIG. 28.

FIG. 8 is a flowchart for illustrating an example of the flow of a hardware-spec inquiry processing that is executed by the load information collection function 214 of the each node to a lower-layer node and the node itself. The load information collection function 214 acquires the items in each column registered in the load basic information management table 223 (step 801). Next, the load information collection function 214 makes inquiries about the items acquired at the step 801 to the node addresses registered in the distribution-destination node management table 225 (step 802). In the present embodiment, the inquiries are made to the distribution-destination nodes to acquire the hardware spec, using SNMP (Simple Network Management Protocol. Although not employed in the present embodiment, in the case of such a value as, e.g., disc access speed that cannot be acquired using SNMP, it is also possible for the manager to directly register the vale into the load basic information management table 223.

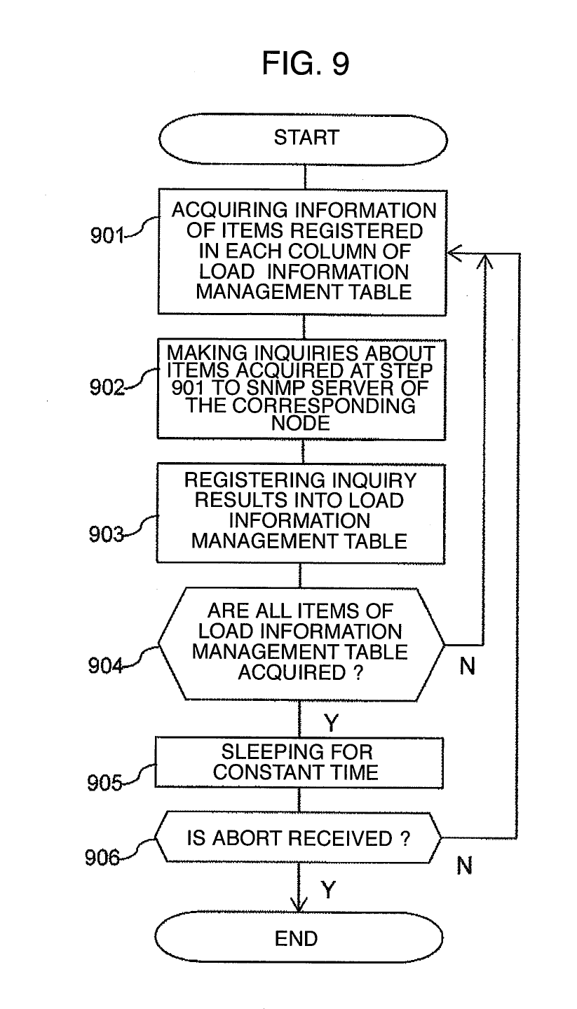

Moreover, the load information collection function 214 registers the inquiry results at the step 802 into the load basic information management table 223 (step 803). The load information collection function 214 confirms whether or not the information has been stored into all the items of the load basic information management table 223, then terminating the processing. If the information has been not yet stored into all the items, the function 214 returns to the step 801, then acquiring the information included in the remaining item (step 804). FIG. 9 is a flowchart for illustrating an example of the flow of a load information inquiry processing that is periodically executed by the load information collection function 214 of the each node to a lower-layer node and the node itself. The load information collection function 214 acquires the items in each column registered in the load information management table 222 (step 901). Next, the load information collection function 214 makes inquiries about the items acquired at the step 901 to the node addresses registered in the distribution-destination node management table 225 (step 902). Moreover, the load information collection function 214 registers the inquiry results at the step 902 into the load information management table 222 (step 903). The load information collection function 214 confirms whether or not the information has been stored into all the items of the load information management table 222, then moving to a step 905. If the information has been not yet stored into all the items, the function 214 returns to the step 901, then acquiring the information included in the remaining item (step 904). The load information collection function 214 sleeps during a constant time-period specified by the manager (step 905). After having slept during the constant time-period at the step 905, the load information collection function 214 confirms the presence or absence of an abort reception from the manager. If the abort is received, the function 214 terminates the processing; whereas, if the abort is not yet received, the function 214 moves to the step 901 (step 906).

Also, in some cases, the CPU usage rate and the like can be caused to rapidly rise instantaneously by a processing (such as, e.g., OS internal processing) that is other than the functions assumed in the present embodiment. In order to use the CPU usage rate while taking a situation like this into consideration, reference is made to the history of the load information in the load history management table 224. Then, when the number of connection(s) is not changed significantly, but when the CPU usage rate is changed significantly, as a rise of the CPU usage rate caused by a processing other than the processings indicated in the present embodiment, a method is conceivable where the CPU usage rate that is one-generation before that of the load history management table 224 is used.

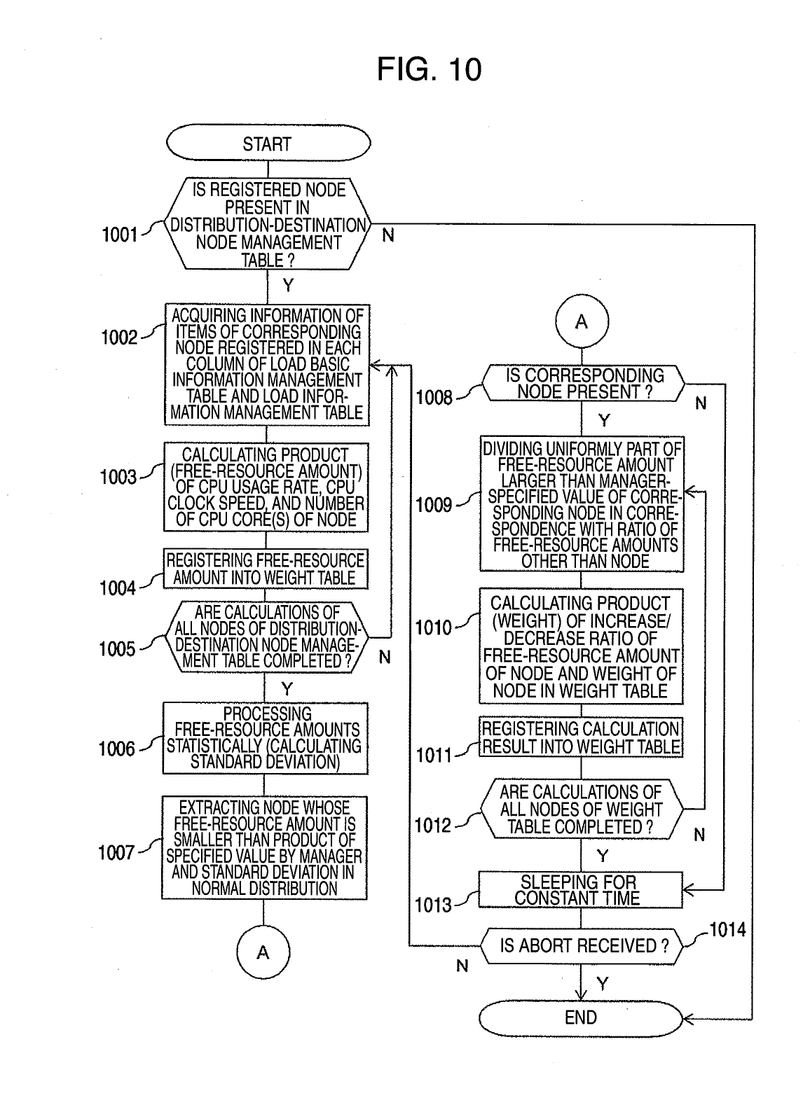

FIG. 10 is a flowchart for illustrating an example of the flow of a calculation processing whereby the weight calculation function 213 of each node calculates the free-resource amount of each node.

The weight calculation function 213 confirms the presence or absence of a record registered in the distribution-destination node management table 225. If the record is present, the function 213 moves to a step 1002; whereas, if the record is absent, the function 213 terminates the processing (step 1001).

Next, on the basis of the node identifier registered in the node name field 601 of the record registered in the distribution-destination node management table 225, the weight calculation function 213 retrieves a record in which the node name field 501 of the load basic information management table 223 and the node name field 401 of the load information management table 222 are the same. Moreover, the function 213 acquires the items in each column registered in the load basic information management table 223 and the load information management table 222 (step 1002).

The weight calculation function 213 calculates the free-resource amount on the basis of the information acquired at the step 1002. In the present embodiment, the function 213 calculates the free-resource amount as was described above, using the CPU clock speed, number of CPU core(s), and CPU usage rate (step 1003).

The weight calculation function 213 registers the free-resource amount calculated at the step 1003 into the free-resource amount field 303 of the record of the weight table 221 which coincides with the corresponding transfer destination of the weight table 221 (step 1004).

Next, the weight calculation function 213 confirms whether or not the function 213 has completed the calculations of the free-resource amounts of all the records registered in the distribution-destination node management table 225. If the calculations are completed, the function 213 moves to a step 1006; whereas, if the calculations are not yet completed, the function 213 moves to the step 1002 (step 1005).

The weight calculation function 213 applies a statistical processing to the free-resource amount calculated at the step 1003. Concretely, the function 213 calculates the standard deviation (step 1006).

Furthermore, the weight calculation function 213 calculates the product of a specified value specified by the manager and the standard deviation calculated at the step 1006. Only when the free-resource amount is smaller than the result of this product, the function 213 extracts the node as an outlier value (step 1007).

The weight calculation function 213 confirms the presence or absence of whether or not the outlier value is extracted at the step 1007. If the outlier value is extracted, the function 213 moves to a step 1009; whereas, if the outlier value is not extracted, the function 213 moves to a step 1013 (step 1008).

The weight calculation function 213 calculates, on each node basis, a difference (hereinafter, referred to as “resource margin amount”) between the free-resource amount of a node that is not extracted at the step 1007, and the product of the specified value specified by the manager and the standard deviation calculated at the step 1006. Meanwhile, the weight calculation function 213 calculates, on each node basis, a difference (hereinafter, referred to as “resource spillover amount”) between the free-resource amount of the node that is extracted as the outlier value at the step 1007, and the product of the specified value specified by the manager and the standard deviation calculated at the step 1006 (step 1009).

The weight calculation function 213 calculates the ratio of the resource spillover amount of the node extracted at the step 1007 in correspondence with the resource margin amount for each node that is not extracted at the step 1007 (step 1010).

Next, the weight calculation function 213 calculates the product of the ratio calculated at the step 1009 and the value registered in the weight field 302 of the weight table 221, then overwriting the calculation result onto the weight field 302 (step 1011).

The weight calculation function 213 confirms whether or not the function 213 has completed the calculations and updates of the weights of all the records registered in the weight table 221. If the updates of all the records are completed, the function 213 moves to the step 1013; whereas, if the updates of all the records are not yet completed, the function 213 moves to the step 1009 (step 1012).

Next, the weight calculation function 213 sleeps during a constant time-period specified by the manager (step 1013).

After having slept during the constant time-period at the step 1013, the weight calculation function 213 confirms the presence or absence of an abort reception from the manager. If the abort is received, the function 213 terminates the processing; whereas, if the abort is not yet received, the function 213 moves to the step 1002 (step 1014).

In the flowchart illustrated in FIG. 10, the calculation example of the free-resource amount using the CPU usage rate is indicated at the step 1003. As described earlier, however, when the free-resource amount is calculated using the load information other than the CPU usage rate, the control is also made possible by basically the same flowchart.

Also, it is possible to perform the control using the number of connection(s) (retention number) recorded in the connection number field 405 of the load information management table 222. For example, it is possible to calculate the free-resource amount indicating to what extent the allowance is present for the resource, using the number of connection(s), hardware spec, and manager-specified resource usage amount per connection of each node. For example, this means that a value indicating what extent of free ratio the product of the resource usage amount per connection and the number of connection(s) occupies relative to the product of the CPU clock speed and the number of CPU core(s) can be mentioned as the free-resource amount.

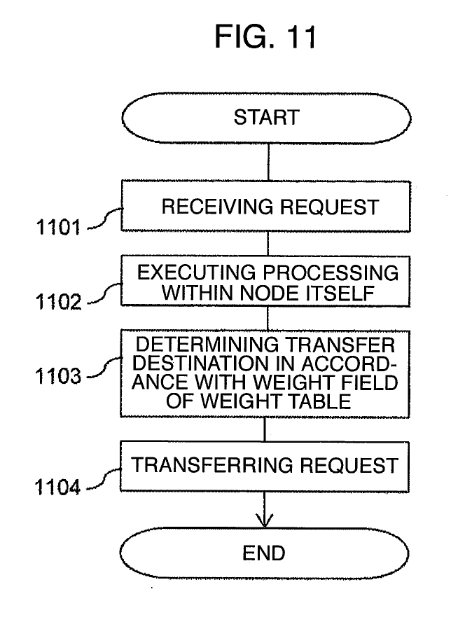

FIG. 11 is a flowchart for illustrating an example of the flow of a processing whereby, in accordance with the registered contents of the weight table 221, the relay function 211 included in each node determines the transfer destination of a processing request transmitted from the client 102 or an upper-layer node. The relay function 211 receives the processing request from the client 102 or the upper-layer node (step 1101). Moreover, the server function 211 carries out the server processing within the node itself (step 1102). Next, the relay function 211 determines the transfer destination in accordance with the ratio of the weights registered in the weight field 302 of the weight table 221. For example, when determining the transfer destination using the round-robin method, the relay function 211 determines the transfer destination in accordance with the ratio of the weights in the sequence of the records registered in the weight field 302 of the weight table 221 (step 1103). Furthermore, the relay function 211 transfers the processing request to the transfer destination determined at the step 1103 (step 1104).

In the present embodiment, the above-described processing flow is executed by the server function 210, the relay function 211, the SNMP function 212, the weight calculation function 213, and the load information collection function 214 included in each node. This allows the node (a) 100 to impellent the distribution of the loads where consideration is given up to the load situation of the nodes (c1) 120a through (c4) 120d in the configuration of the computer system illustrated in FIG. 1. Incidentally, since the distribution is performed on the basis of the information of the free-resource amounts, it becomes possible to implement the equalization of the loads.

In the present embodiment, the explanation has been given concerning the example where the free-resource amount is used as the load allowance amount of each node. However, even in the case of the way of thinking where the usage amounts of the CPU and the like are actually used, it is possible to implement the equalization of the loads similarly.

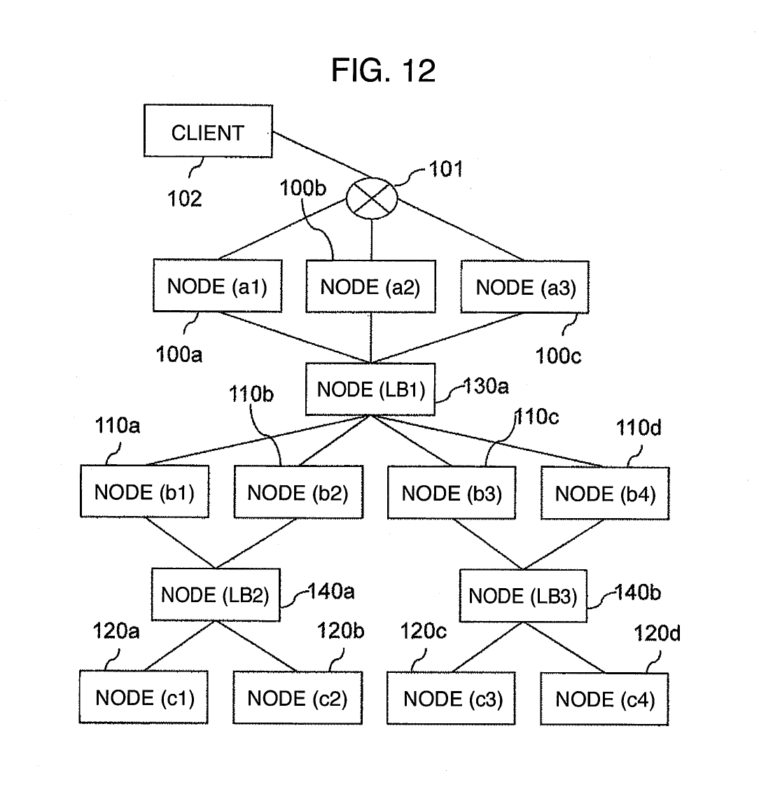

Also, FIG. 12 illustrates a configuration example where the configuration of the computer system illustrated in FIG. 1 is changed as follows: A node (LB1) 130a is deployed between the layer of a node (a1) 100a through a node (a3) 100c and the layer of a node (b1) 110a through a node (b4) 110d. A node (LB2) 140a and a node (LB3) 140b are deployed between the layer of the node (b1) 110a through the node (b4) 110d and the layer of a node (c1) 120a through a node (c4) 120d. Even in the case where the layers are increased in this way, it is made possible by the method illustrated in the first embodiment to report the load on a lower-layer node to an upper-layer node. As a result, it is possible to carry out the load decentralization after grasping the node situation of each layer.

However, the configuration illustrated in FIG. 12 differs from the configuration illustrated in FIG. 1 in a point that it is not the tree structure constructed in a radial manner from an upper-layer node to lower-layer nodes. In addition to the method illustrated in the first embodiment, in the node (LB1) 130a for example, the particle size of the information registered into the connection number field 405 of the load information management table 222 is made fine in the transfer-destination unit, and the free-resource amount is distributed in accordance with its ratio. This makes it possible to implement the load decentralization based on the situation of each node of each layer.

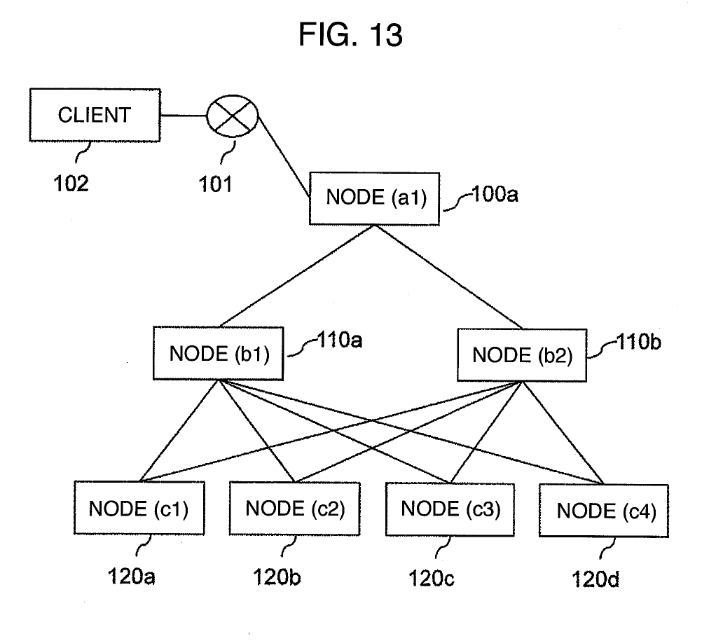

Also, FIG. 13 illustrates a connection mode example where the configuration of the computer system illustrated in FIG. 1 is changed as follows: Each of the lower-layer node (c1) 120a through the lower-layer node (c4) 120d is connected to the plurality of upper-layer node (b1) 110a through upper-layer node (b2) 110b. Even in the configuration illustrated in FIG. 13, it is possible to implement the load decentralization similarly.

For example, as the load information collected by the load information collection functions 214 of the node (b1) 110a through the node (b2) 110b, when returning the CPU usage rate and the like as the response, the SNMP functions 212 of the node (c1) 120a through the node (c4) 120d return, as the CPU usage rate, a value obtained by dividing the CPU usage rate by a ratio at which the SNMP functions 212 have received the processing request from the node (b1) 110a through the node (b2) 110b. This makes it possible to implement the load decentralization based on the situation of the node of each layer.

Incidentally, if a failure has occurred in a certain node, it becomes impossible to collect the load information from this failure-occurred node. However, the free-resource amount of this node whose load information cannot be collected is set at zero. This processing prevents the processing request from being transferred to this node, thereby making it possible to continue the service. The case of decreasing the installment of a node can be addressed by a similar method. Meanwhile, the case of increasing the installment of a node can be addressed by executing the record addition into the distribution-destination node management table 225 or the like with respect to the parent node of this installment-increased node. In this way, it is possible to easily address such situations as the scale-out, scale-down, and node-failure occurrence. Simultaneously, it is possible to implement the configuration change in the service-no-halt state.

The explanation concerned is not given in the configuration of the computer system indicated in the present embodiment. In general, however, the redundancy of a node is performed as the countermeasure against its failure. For example, when the redundancy of a parent node is performed, a child node transmits same information to the resultant two or more parent nodes that are in the redundant state. This processing makes it possible to apply the load decentralization method indicated in the present embodiment, even if a system switching or the like should occur.

### Embodiment 2

In the first embodiment, the configuration including one uppermost node (root node) has been selected as the target. In the second embodiment, however, the explanation will be given blew concerning a load decentralization method where the connection configuration including a plurality of root nodes is selected as the target. In the explanation hereinafter, the explanation will be given such that points different from the first embodiment are positioned at the center.

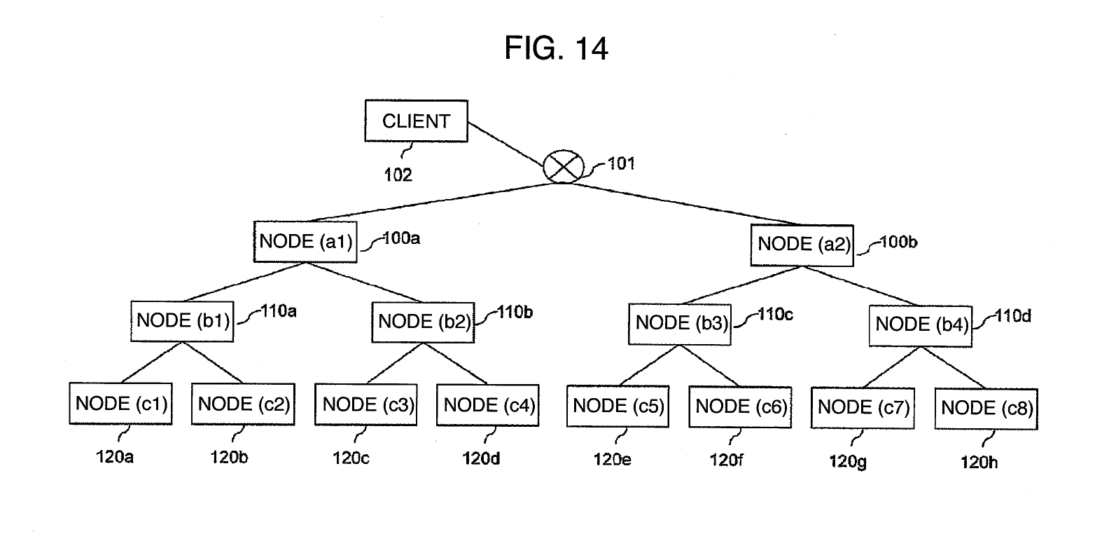

FIG. 14 is a diagram for illustrating a configuration example of the computer system. The node (a1) 100a and the node (a2) 100b, which become root nodes, are connected to the client 102 via the network 101. The connection mode of the lower-layer nodes lower than the node (a1) 100a and the node (a2) 100b is basically the same as the configuration illustrated in FIG. 1 of the first embodiment. The number of the root nodes may be three or more.

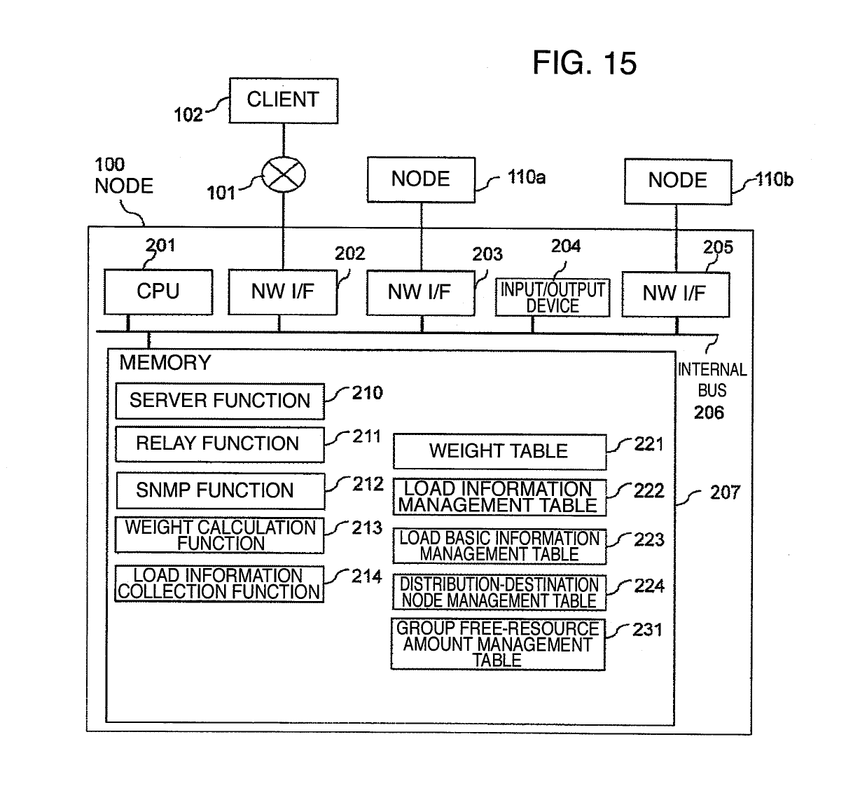

FIG. 15 is a diagram for illustrating a configuration example of the root nodes where a group free-resource amount management table 231 is newly added to the configuration example of the nodes illustrated in FIG. 2. The group free-resource amount management table 231 is a table for managing the free-resource amounts in the root-node unit.

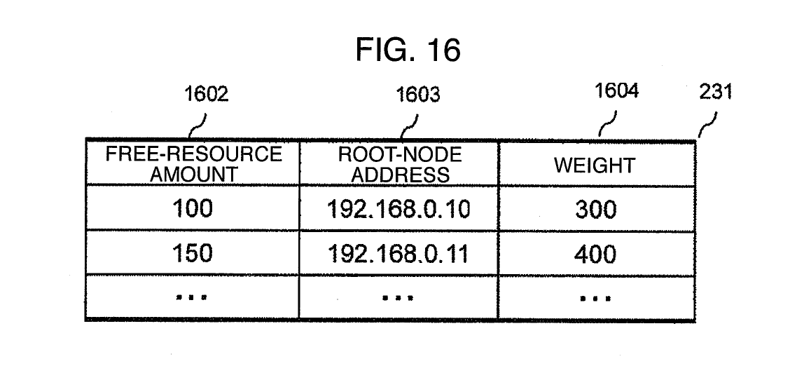

FIG. 16 is a diagram for illustrating an example of the group free-resource amount management table 231 included in each root node. A free-resource amount field 1602 of the group free-resource amount management table 231 stores therein the free-resource amounts of the entire nodes lower than each root node. A root-node address field 1603 thereof stores therein the address information on the root node itself and the other root node. A weight field 1604 thereof stores therein the weight value corresponding to the load amount of each root node.

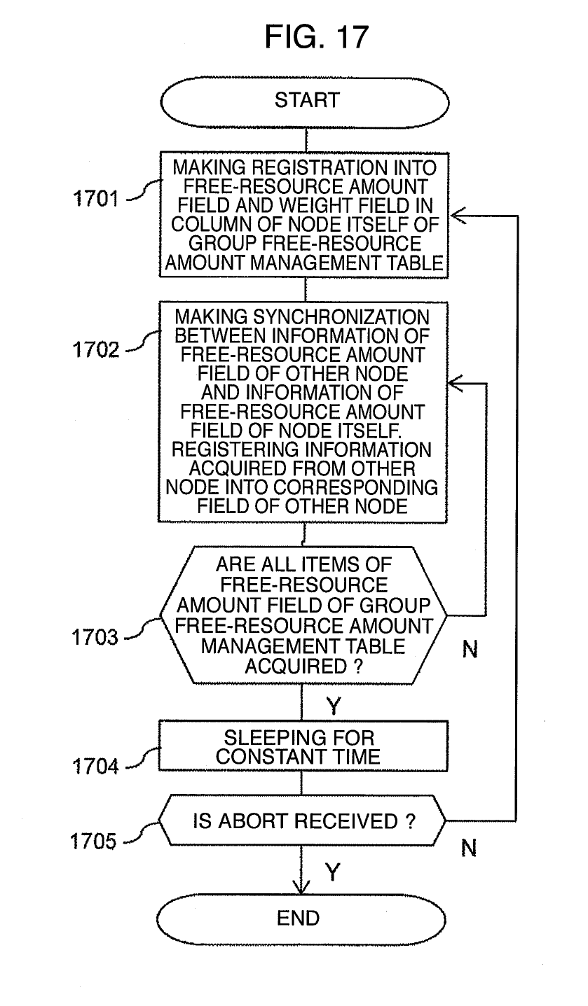

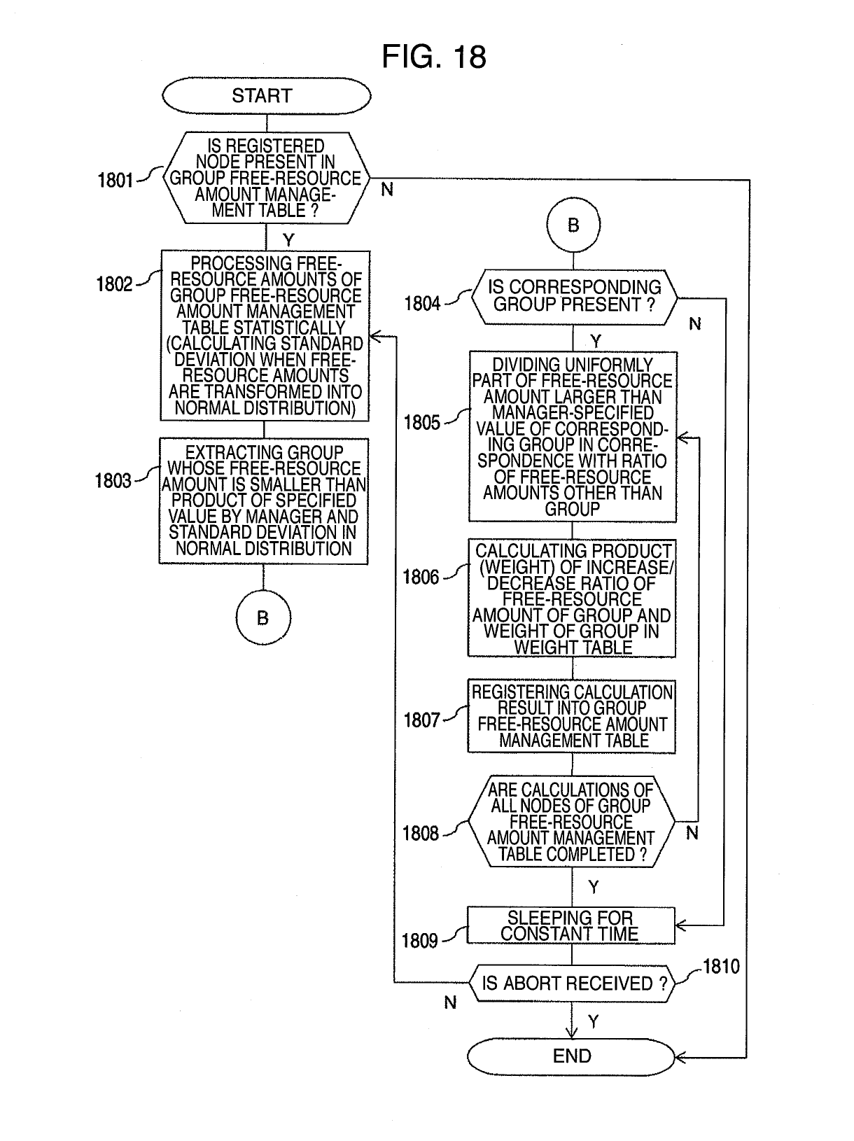

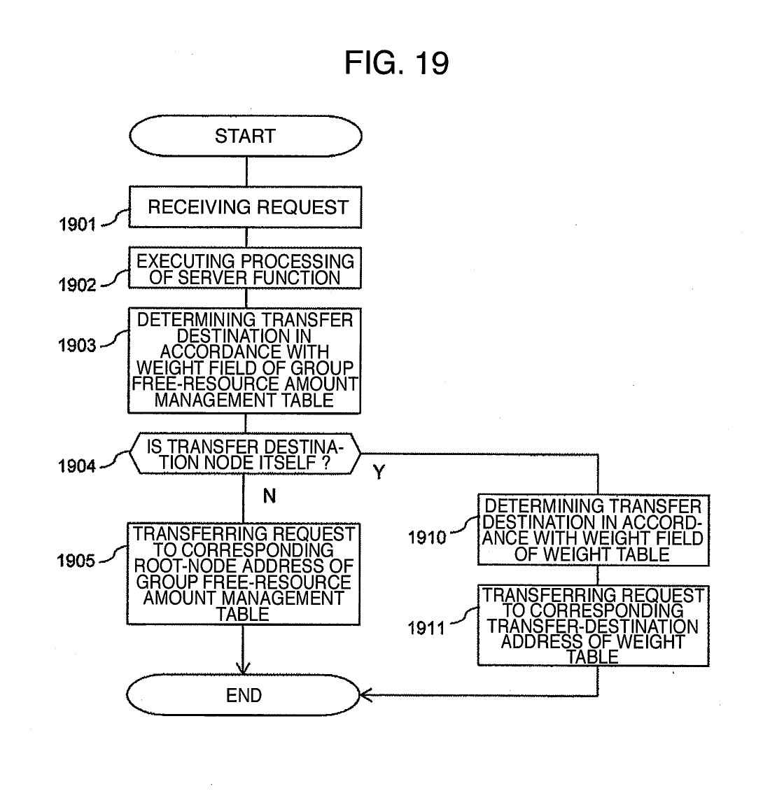

In the second embodiment, in addition to the flowchart illustrated in FIG. 28 of the first embodiment, each root node makes reference to the group free-resource amount management table 231 illustrated in FIG. 16, thereby determining the transfer destination of a processing request in correspondence with the load on each node lower than the plurality of root nodes. Each node lower than the plurality of root nodes executes basically the same processings as the processings up to the step 2804 in FIG. 28. Furthermore, each root node executes flowcharts illustrated in FIG. 17 and FIG. 18, thereby acquiring the free-resource amount between the groups. After receiving the processing request from the client 102, each root node executes steps 1902 to 1911 in FIG. 19, thereby determining the transfer destination of the processing request between the plurality of root nodes.

FIG. 17 is a flowchart for illustrating an example of the flow of a processing whereby the load information collection function 214 registers information into the group free-resource amount management table 231. This processing is carried out in each root node which is positioned in the uppermost layer, and to which the inquiry about the free-resource amount is not made.

With respect to the record corresponding to the node itself (root node), the load information collection function 214 registers the free-resource amount of the node itself into the free-resource amount field 1602, and registers the address information on the node itself into the root-node address field 1603 (step 1701). On the basis of the address information registered in the root-node address field 1603 of the record corresponding to the other root node of the group free-resource amount management table 231, the load information collection function 214 makes an inquiry about the free-resource amount to the other root node, and performs the transmission Of the free-resource amount of the node itself to the other root node (step 1702).

The load information collection function 214 confirms whether or not all the records of the group free-resource amount management table 231 have been updated. If all the records have been updated, the load information collection function 214 moves to a step 1704; whereas, if not, the function 214 moves to the step 1702 (step 1703). Next, the load information collection function 214 sleeps during a constant time-period specified by the manager (step 1704). Moreover, after having slept during the constant time-period at the step 1704, the load information collection function 214 confirms the presence or absence of an abort reception from the manager. If the abort is received, the function 214 terminates the processing; whereas, if the abort is not yet received, the function 214 moves to the step 1701 (step 1705).

FIG. 18 is a flowchart for illustrating an example of the flow of a calculation processing whereby the weight calculation function 213 calculates the weights between the root nodes on the basis of the free-resource amounts of the group free-resource amount management table 231. First of all, the weight calculation function 213 confirms whether or not a plurality of records including the node itself and the other root node exist as the records registered in the group free-resource amount management table 231. If the records exist, the function 213 moves to a step 1802; whereas, if the records do not exist, the function 213 terminates the processing (step 1801). With respect to the next steps 1802 to 1806, the processing contents are basically the same as those at the steps 1006 to 1010 in FIG. 10. Accordingly, the explanation thereof will be omitted here.

Subsequently, the explanation will be given below concerning a step 1807 and thereinafter. The weight calculation function 213 calculates the product of the ratio calculated at the step 1806 and the value registered in the weight field 1604 of the group free-resource amount management table 231, then overwriting the calculation result onto the weight field 1604 (step 1807). Next, the weight calculation function 213 confirms whether or not the function 213 has completed the calculations and updates of the weights of all the records of the group free-resource amount management table 231. If the updates of all the records are completed, the function 213 moves to a step 1809; whereas, if the updates of all the records are not yet completed, the function 213 moves to the step 1805 (step 1808). Moreover, the weight calculation function 213 sleeps during a constant time-period specified by the manager (step 1809). After having slept during the constant time-period at the step 1809, the weight calculation function 213 confirms the presence or absence of an abort reception from the manager. If the abort is received, the function 213 terminates the processing; whereas, if the abort is not yet received, the function 213 moves to the step 1802 (step 1810).

FIG. 19 is a flowchart for illustrating an example of the flow of a processing whereby, in accordance with the registered contents of the weight field 1604 of the group free-resource amount management table 231, the relay function 211 determines the transfer destination of a processing request transmitted from the client 102.

For example, consideration is given to a case where relay nodes (root nodes) is specified as the specification of default gateway for each client 102. The relay function 211 of any one of the root nodes receives the processing request from the client 102 (step 1901). Moreover, the server function 210 carries out the server processing within the node itself (step 1902). Next, the relay function 211 determines the transfer-destination root node in accordance with the ratio of the weights registered in the weight field 1604 of the group free-resource amount management table 231 (step 1903). The logic here is basically the same as the step 1103 in FIG. 11.

Furthermore, at a step 1904, the relay function 211 confirms whether or not the transfer destination is the node itself. If the transfer destination is the node itself, the function 211 moves to a step 1910; whereas, if the transfer destination is the root node other than the node itself, the function 211 moves to a step 1905 (step 1904). If the transfer destination is the root node other than the node itself, the relay function 211 transfers the processing request to the transfer-destination root node determined at the step 1903, using the network 101 (step 1905). Meanwhile, if the transfer destination is the node itself, the function 211 determines the transfer destination in accordance with the ratio of the weights registered in the weight field 302 of the weight table 221 (step 1910). The processing at this step 1910 is the same as the step 1103 in FIG. 11. In addition, the relay function 211 transfers the processing request to the lower-layer node that becomes the transfer destination determined at the step 1910 (step 1911).

In the present embodiment, the above-described processing flow is executed by the server function 210, the relay function 211, the weight calculation function 213, and the load information collection function 214 included in each node. This allows the node (a1) 100a and the node (a2) 100b to impellent the load decentralization where consideration is given up to the load situation of the nodes (c1) 120a through (c8) 120h in the configuration of the computer system illustrated in FIG. 14. In the present embodiment, only the root-node free-resource amounts are synchronized with each other between the root nodes in the uppermost layer. This makes it possible to impellent the load decentralization based on the synchronization with the minimum information amount.

Also, when the installment of a root node is newly increased, the manager updates only the group free-resource amount management table 231. This allows the system to recognize the root node as a new distribution destination, thereby making it possible to implement the scale-out or scale-down easily.

### Embodiment 3

In the third embodiment, the explanation will be given blew concerning a load decentralization method where the DNS is used when a processing request from the client 102 is distributed to each root node. In the explanation hereinafter, the explanation will be given such that points different from the first and second embodiments are positioned at the center.

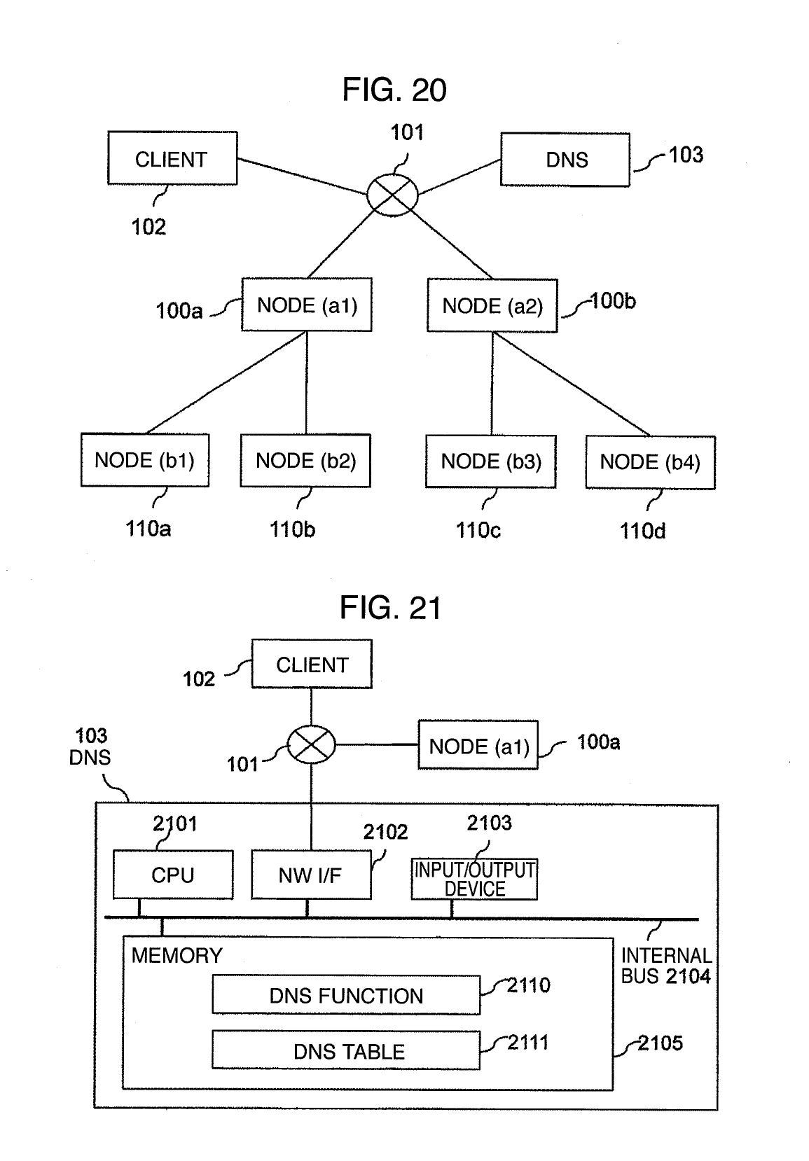

FIG. 20 is a diagram for illustrating a configuration example of the computer system. This is a configuration where, in addition to the configuration illustrated in FIG. 1 of the first embodiment, a DNS server 103 is connected to the network 101. The client 102 makes an inquiry to the DNS server 103 for implementing a name solution processing. The DNS server 103 replies an appropriate access destination to the inquiry, thereby allowing the client 102 to transmit the processing request to the appropriate node.

FIG. 21 is a diagram for illustrating a configuration example of the DNS server 103. The DNS server 103 is implemented on a computer where one or more CPUs 2101, one or more network interfaces (NW I/Fs) 2102, an input/output device 2103, and a memory 2105 are connected to each other via a communications path 2104 such as internal bus. The NW I/Fs 2102 are connected to the client 102 and the root node (a1) 100a or the root node (a2) 100b via the network 101. The memory 2105 stores therein a DNS function 2110 executed by the CPUs 2101, and a DNS table 2111. Having received a name solution processing request from the client 102, the DNS function 2110 replies the appropriate access destination to the client 102 in accordance with the contents of the DNS table 2111.

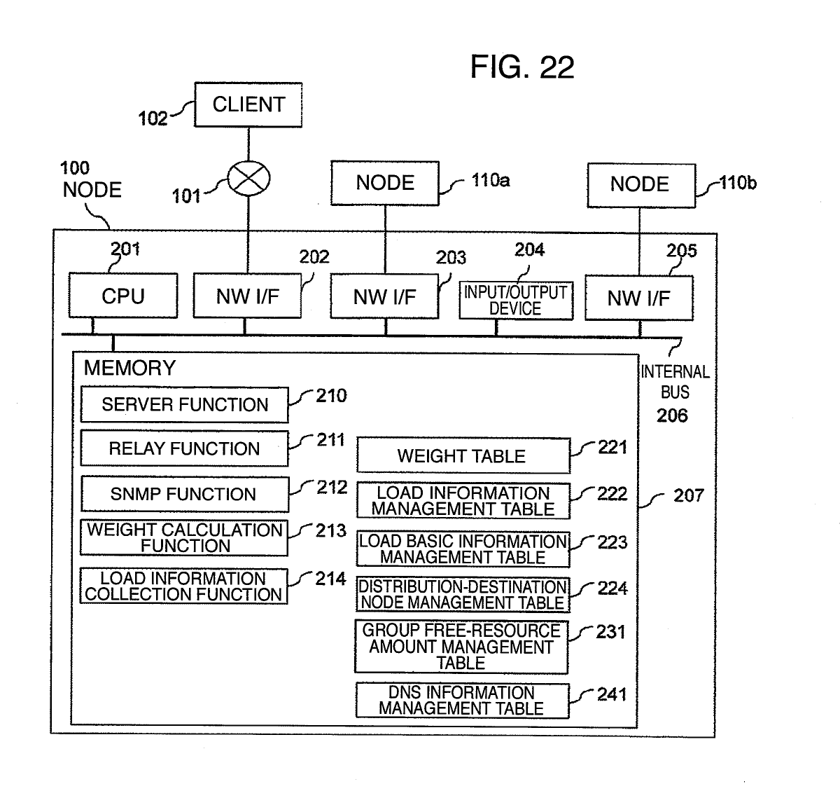

FIG. 22 is a diagram for illustrating a configuration example of the nodes where a DNS information management table 241 is newly added to the configuration example of the nodes illustrated in FIG. 15. The DNS information management table 241 is a table for managing the address information on the DNS server 103.

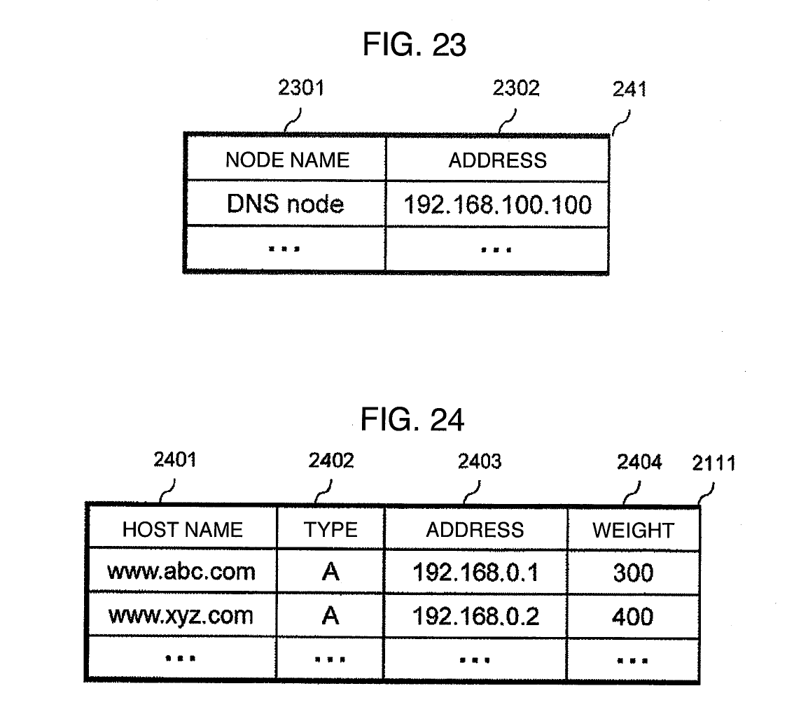

FIG. 23 is a diagram for illustrating an example of the DNS information management table 241 included in each node. The DNS information management table 241 is included in each root node (the node that directly receives the processing request from the client). A node name field 2301 of the DNS information management table 241 registers therein the identifier of the DNS server 103. An address field 2302 thereof registers therein the address information on the DNS server 103.

FIG. 24 is a diagram for illustrating an example of the DNS table 2111 included in the DNS server 103. When the DNS function 2110 of the DNS server 103 receives the name solution processing request from the client 102, the DNS function 2110 makes reference to the DNS table 2111 in order to determine the appropriate access destination. A host name field 2401 of the DNS table 2111 registers therein the host name of a domain that receives the inquiry from the client 102. A type field 2402 thereof registers therein the type of the corresponding record. An address field 2403 thereof registers therein the address information on the access destination for the domain. A weight field 2404 thereof registers therein the weight information on the access destination for the domain.

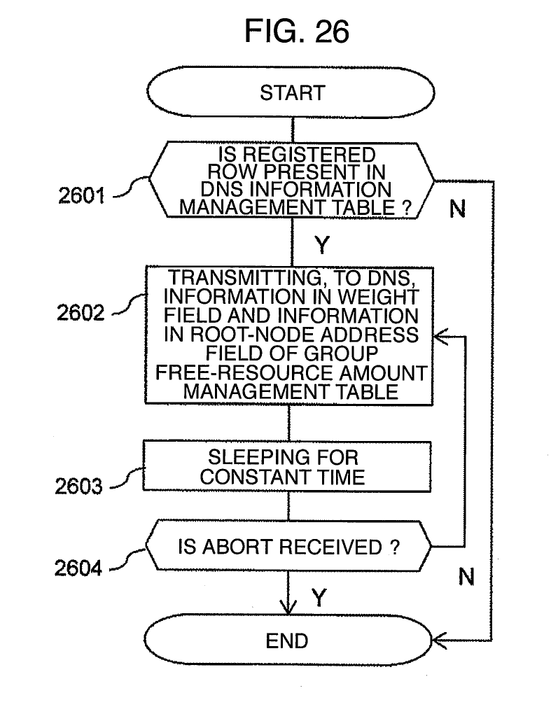

FIG. 26 is a flowchart for illustrating an example of the flow of a processing whereby the weight calculation function 213 included in each parent node transmits weight information to the DNS server 103. The weight calculation function 213 confirms whether or not a registered record exists in the DNS information management table 241. If the registered record exists, the function 213 moves to a step 2602; whereas, if the registered record does not exist, the function 213 terminates the processing (step 2601). If, at the step 2601, the registered record exists in the DNS information management table 241, the weight calculation function 213 transmits the information, which is registered in the root-node address field 1603 and the weight field 1604 of the group free-resource amount management table 231, to the registered address of the address field of the record registered in the DNS information management table 241 (step 2602). Moreover, the weight calculation function 213 sleeps during a constant time-period specified by the manager (step 2603). After having slept during the constant time-period at the step 2603, the weight calculation function 213 confirms the presence or absence of an abort reception from the manager. If the abort is received, the function 213 terminates the processing; whereas, if the abort is not yet received, the function 213 moves to the step 2602 (step 2604).

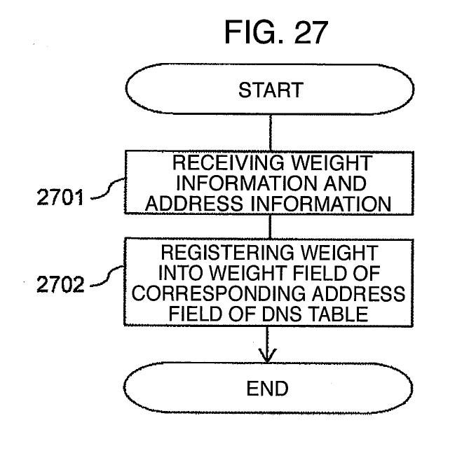

FIG. 27 is a flowchart for illustrating an example of the flow of a processing whereby the DNS function 2110 included in the DNS server 103 receives the weight information from each root node. The DNS function 2110 receives the address information and the weight information from the root node (step 2701). Next, the DNS function 2110 retrieves a record in which the address information received at the step 2701 coincides with the address field 2403 of the DNS table 2111, then overwriting the weight information received at the step 2701 over the weight field 2404 of this record (step 2702).

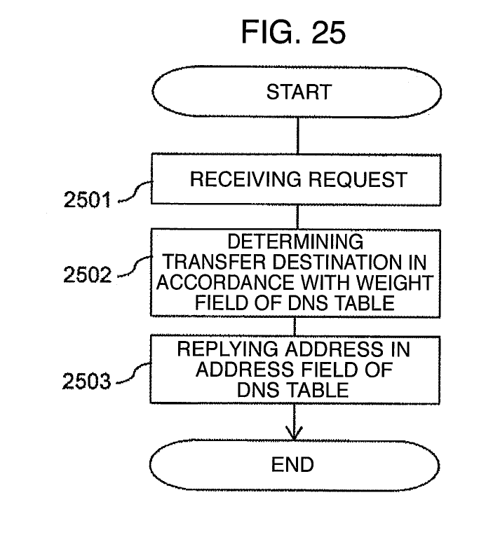

FIG. 25 is a flowchart for illustrating an example of the flow of a processing whereby the DNS function 2110 included in the DNS server 103 makes the response to the name solution processing request from the client 102 in accordance with the registered contents of the DNS table 2111.

The DNS function 2110 receives the name solution processing request from the client 102 (step 2501). The DNS function 2110 extracts a record in which the host name of the name solution processing request that it has received and the host name field 2401 of the DNS table 2111 coincide with each other. If a plurality of records are extracted, the DNS function 2110 selects a record in accordance with the information of the weight field 2404. The selection method here is basically the same as the distribution-destination determination method in the above-described node. However, basically the same method need not be used, but it is allowable to employ a selection method in response to the unique weight of the DNS server 103 (step 2502). Next, the DNS function 2110 replies, to the client 102, the address information registered in the address field 2403 of the record determined at the step 2502 (step 2503).

In the present embodiment, when the DNS server 103 makes the response to the name solution processing request from the client 102, the DNS server 103 determines the address to which the response is to be made on the basis of the weight acquired from the root node. This makes it possible to impellent the load decentralization where consideration is given up to the lower-layer nodes as described in the first embodiment. Also, if there exists a plurality of DNS servers such as priority DNS server and alternative DNS server, it turns out that the nodes are registered into the group free-resource amount management table 231. Accordingly, the weight information is conveyed into the respective DNS servers. Consequently, even if to which of the DNS servers the client has made the inquiry about the name solution processing, it becomes possible to impellent the load decentralization where consideration is given up to the lower-layer nodes.

The above-described embodiments are intended for the exemplification purpose, and are not intended for the limitation purpose. A variety of modifications and amendments of these embodiments, which are apparent for those who are skilled in the art, are included within the spirit and range of the present disclosure determined by the scope of the appended claims.

1. A load decentralization method in a network system where a plurality of nodes are coupled to each other over three or more layers, and where an uppermost root node transfers a processing request received to a lower-layer node and has the lower-layer node process the request,
where one node of a (n+1)-th layer in arbitrary three layers (n-th through (n+2)-th layers) executing:
acquiring respective load information on one or more nodes of the (n+2)-th layer therefrom;
calculating free-resource amount of the one node itself on the basis of the respective load information acquired and load information on the one node itself; and
transmitting the calculated free-resource amount of the one node itself to a node of the n-th layer, and
the node of the n-th layer executing:
calculating weight values on the basis of free-resource amounts acquired from respective nodes of the (n+1)-th layer; and
distributing the received processing request to any one of the respective nodes of the (n+1)-th layer on the basis of the weight values calculated.

2. The load decentralization method according to claim 1,
where the network system comprises the plurality of root nodes, and
where each of the root nodes further executing:
acquiring free-resource amounts from respective nodes of the second layer coupled to the root node itself;
calculating weight values on the basis of the free-resource amounts acquired from the respective nodes of the second layer;
transmitting the calculated weight values to another root node, and acquiring weight values of the other root node from the other root node; and
distributing the received processing request to any one of the root nodes including the node itself on the basis of the weight values of the root node itself and the other root node.

3. The load decentralization method according to claim 1,
where the network system comprises the plurality of root nodes and a DNS server, and
where each of the root nodes further executing:
acquiring free-resource amounts from respective nodes of the second layer coupled to the root node itself;
calculating weight values on the basis of the free-resource amounts acquired from the respective nodes of the second layer; and
transmitting, to the DNS server, the calculated weight values and address information on the root node.

4. The load decentralization method according to claim 1,
where the node of the n-th layer further executing:
calculating standard deviations of the free-resource amounts acquired from the respective nodes of the (n+1)-th layer; and
calculating the weight values on the basis of the standard deviations and a specified value determined in advance.

5. The load decentralization method according to claim 1,
where the free-resource amount being calculated on the basis of CPU usage rate, or number of connections.

6. A network system where a plurality of nodes are coupled to each other over three or more layers, and where a processing request received by an uppermost root node is processed by being transferred to a lower-layer node, wherein
one node of a (n+1)-th layer in arbitrary three layers (n-th through (n+2)-th layers) comprises:
a function of acquiring respective load information on one or more nodes of the (n+2)-th layer therefrom;
a function of calculating free-resource amount of the one node itself on the basis of the respective load information acquired and load information on the one node itself; and
a function of transmitting the calculated free-resource amount of the one node itself to a node of the n-th layer,
the node of the n-th layer comprising:
a function of calculating weight values on the basis of free-resource amounts acquired from respective nodes of the (n+1)-th layer; and
a function of distributing the received processing request to any one of the respective nodes of the (n+1)-th layer on the basis of the weight values calculated.

7. The network system according to claim 6, wherein,
when the network system comprises the plurality of root nodes,
each of the root nodes comprises:
a function of acquiring free-resource amounts from respective nodes of the second layer coupled to the root node itself;
a function of calculating weight values on the basis of the free-resource amounts acquired from the respective nodes of the second layer;
a function of transmitting the calculated weight values to another root node, and a function of acquiring weight values of the other root node from the other root node; and
a function of distributing the received processing request to any one of the root nodes including the node itself on the basis of the weight values of the root node itself and the other root node.

8. The network system according to claim 7, wherein,
when the network system comprises the plurality of root nodes and a DNS server,
each of the root nodes comprises:
a function of acquiring free-resource amounts from respective nodes of the second layer coupled to the root node itself;
a function of calculating weight values on the basis of the free-resource amounts acquired from the respective nodes of the second layer; and
a function of transmitting, to the DNS server, the calculated weight values and address information on the root node.

9. The network system according to claim 6, wherein
the node of the n-th layer comprises:
a function of calculating standard deviations of the free-resource amounts acquired from the respective nodes of the (n+1)-th layer; and
a function of calculating the weight values on the basis of the standard deviations and a specified value determined in advance.

10. The network system according to claim 6, comprises:
a function of calculating the free-resource amount on the basis of CPU usage rate, or number of connections.

11. A plurality of root nodes when the plurality of root nodes are included in a network system where a plurality of nodes are coupled to each other over three or more layers, and where a processing request received by the uppermost root node of the root nodes is processed by being transferred to a lower-layer node, wherein
each of the root nodes comprises:
a function of acquiring free-resource amounts of respective nodes of the second layer from the respective nodes of the second layer coupled to the root node itself;
a function of calculating weight values on the basis of the free-resource amounts acquired from the respective nodes of the second layer;
a function of transmitting the calculated weight values to another root node;
a function of acquiring weight values of the other root node from the other root node; and
a function of distributing the received processing request to any one of the root nodes including the node itself on the basis of the weight values of the root node itself and the other root node.

12. The root nodes according to claim 11, wherein
each of the root nodes comprises:
a function of calculating standard deviations of the free-resource amounts acquired from the respective nodes of the second layer; and
a function of calculating the weight values on the basis of the standard deviations and a specified value determined in advance.

13. A plurality of root nodes when the plurality of root nodes and a DNS server are included in a network system where a plurality of nodes are coupled to each other over three or more layers, and where a processing request received by the uppermost root node of the root nodes is processed by being transferred to a lower-layer node, wherein
each of the root nodes comprises:
a function of acquiring free-resource amounts of respective nodes of the second layer from the respective nodes of the second layer coupled to the root node itself;
a function of calculating weight values on the basis of the free-resource amounts acquired from the respective nodes of the second layer; and
a function of transmitting, to the DNS server, the calculated weight values and address information on each of the root nodes.

14. The root nodes according to claim 13, wherein
each of the root nodes comprises:
a function of calculating standard deviations of the free-resource amounts acquired from the respective nodes of the second layer; and
a function of calculating the weight values on the basis of the standard deviations and a specified value determined in advance.
